(19) United States
(12) Patent Application Publication
(10) Pub. No.: US 2026/0168944 A1
(43) Pub. Date: Jun. 18, 2026

(54) METHOD FOR EVALUATING DEFECT POSITION IN DEPTH DIRECTION OF WAFER

(71) Applicant: SHIN-ETSU HANDOTAI CO., LTD., Tokyo (JP)

(72) Inventor: Hisayuki SAITO, Shirakawa-shi (JP)

(73) Assignee: SHIN-ETSU HANDOTAI CO., LTD., Tokyo (JP)

(21) Appl. No.: 19/125,044

(22) PCT Filed: Sep. 11, 2023
(86) PCT No.: PCT/JP2023/032948

§ 371 Date: Apr. 28, 2025

(30) Foreign Application Priority Data
Nov. 9, 2022 (JP) 2022-179236

(51) Int. Cl. G01N 23/2055

(52) U.S. Cl. CPC G01N 23/2055; G01N 2223/0566; G01N 2223/401; G01N 2223/414; G01N 2223/6462

(57) ABSTRACT

A method for evaluating a defect position in a depth direction of a wafer using X-ray topography (XRT), the method includes the steps of irradiating a front surface of the wafer that has the front surface and a back surface with an X-ray from a right direction and a left direction at an incident angle satisfying diffraction conditions to obtain two XRT images, being a right-eye image and a left-eye image, on the back surface, position-adjusting to adjust the two obtained XRT images at the defect position on any one of the front surface and the back surface, and determining the defect position to determine another defect position, where the position in the depth direction of the wafer is different, based on a displacement between the right-eye image and the left-eye image.

### TECHNICAL FIELD

The present invention relates to a method for evaluating a defect position in a depth direction of a wafer using X-ray topography (XRT).

### BACKGROUND ART

X-ray topography (XRT) is an apparatus widely used for observing defects in materials for crystals, in particular, semiconductor device materials represented by silicon wafers. The XRT has a different measurement principle from X-ray CT and detects strain of diffraction grating instead of a difference in transmittance. Consequently, the XRT is only applicable to single crystals but can measure extremely small defects.

In a transmissive method of the XRT, defect positions across an entire wafer can be identified, but information such as the depth of the defects cannot be obtained. The depth information on the defects of the semiconductor device materials is extremely important information for determining whether or not the defects affect failures of the devices. In recent years, in order to obtain the depth information using XRT, it is now possible to obtain cross-sectional topograph and three-dimensional topograph obtained by combining a plurality of the cross-sectional topographs but an extremely long time measurement is required to obtain the cross-sectional topograph and even longer time is required to obtain the three-dimensional data that requires a plurality of the cross-sectional topograph information. As a result, many constraints are present, such as the necessity of using synchrotron radiation, being a strong X-ray source, for the measurement.

In this way, it has been conventionally difficult to convert cross-sectional topography images by overlaying thereof into three-dimensional data, but in recent years, a method has been developed to enable the conversion of defect data into three-dimensional data (for example, Patent Document 1). Even with this method, however, it still takes time to obtain the three-dimensional data, and a problem exists in that measurement regions are narrow.

Furthermore, in semiconductor device materials, it is extremely important whether the defects causing the device failures are on a front surface, which is a device layer, or a back surface, but the XRT has not been able to evaluate the depth position of the defects by a simple and easy method.

### CITATION LIST

### Patent Literature

Patent Document 1: JP 2015-105831 A

### SUMMARY OF INVENTION

### Technical Problem

The present invention has been made in view of the above-described problem. An object of the present invention is to provide a method for evaluating a defect position in a depth direction of a wafer by a simple and easy method using X-ray topography (XRT).

### Solution to Problem

To achieve the object, the present invention provides a method for evaluating a defect position in a depth direction of a wafer using X-ray topography (XRT), the method comprising the steps of:
irradiating a front surface of the wafer that has the front surface and a back surface with an X-ray from a right direction and a left direction at an incident angle satisfying diffraction conditions to obtain two XRT images, being a right-eye image and a left-eye image, on the back surface;
position-adjusting to adjust the two obtained XRT images at the defect position on any one of the front surface and the back surface; and
determining the defect position to determine another defect position, where the depth direction of the wafer is different, based on a displacement between the right-eye image and the left-eye image.

According to the method for evaluating a defect position in a depth direction of a wafer, the right-eye image and the left-eye image are matched for the defects on the position-adjusted surface, but the displacement is generated between the right-eye image and the left-eye image for the defects on a different surface from the position-adjusted surface, and this displacement can be used to determine that the defects have different positions in the depth direction. With this method, it is sufficient to obtain only two images through normal usage of X-ray topography (XRT), and the measurement can be performed in a short time, additionally, special usages such as intensifying synchrotron radiation or narrowing a measurement region are not performed, resulting in versatility. As a result, it is possible to evaluate the defect position in the depth direction of the wafer using an extremely simple and easy method.

In addition, it is preferable that the method for irradiating the front surface with the X-ray from the right direction and the left direction at the incident angle satisfying the diffraction conditions obtains the two XRT images, being the right-eye image and the left-eye image, by fixing an incident angle in either direction of the right direction or the left direction and obtaining the XRT image by irradiating the X-ray and then rotating the wafer by 180° and then obtaining the XRT image from another direction by irradiating with the X-ray.

With such a method, it is possible to easily obtain the XRT images in the right direction and the left direction without moving an X-ray generator or detector; therefore, the defect positions in the depth direction of the wafer can be evaluated by the extremely simple and easy method.

Moreover, it is preferable that the step of determining the defect position determines the defect position by inverting black-and-white of any one of the two obtained XRT images and combining thereof.

With such a step of determining the defect position, the defect position can be reliably evaluated by the color difference between black and white; therefore, such a step can be suitably applied to the method for evaluating a defect position in a depth direction of a wafer.

The present invention provides a method for evaluating a defect position in a depth direction of a wafer using X-ray topography (XRT), wherein
by irradiating a front surface of the wafer that has the front surface and a back surface with an X-ray from a right direction and a left direction at an incident angle satisfying diffraction conditions to obtain two XRT images, being a right-eye image and a left-eye image, on the back surface and then by visually capturing the two XRT images as a single image, the defect position in the depth direction is observed through stereoscopic viewing (3D image).

According to the method for evaluating a defect position in a depth direction of a wafer, when the two XRT images are attempted to be visually captured as the single image, the defects having different positions in the depth direction are observed stereoscopically due to the displacement of the two images; consequently, these defects can be determined as the defects having different positions in the depth direction due to a visual appearance in three-dimensional. With this method, it is sufficient to obtain only two images through normal usage of X-ray topography (XRT), and the measurement can be performed in a short time, additionally, special usages such as intensifying synchrotron radiation or narrowing the measurement region are not performed, resulting in versatility. In addition, since the evaluation of the defect positions is performed visually, no separate preparation of the evaluation apparatus, etc., is required. As a result, it is possible to evaluate the defect positions in the depth direction of the wafer using the extremely simple and easy method.

Moreover, the wafer is preferably at least one of a single crystal wafer and a wafer on which a device has been formed.

Such a wafer can be suitably applied for a method for evaluating a defect position in a depth direction of a wafer using X-ray topography (XRT). In particular, when a silicon wafer and a SiC wafer are used, some incident angle satisfying diffraction conditions have been known in advance, and this can be suitably applied to the method for evaluating a defect position in a depth direction of a wafer.

Moreover, when the SiC wafer is used, a case where a crystal defect is intricately intertwined within a crystal may occur, and this method can be applied to confirm the situation therein.

Furthermore, when the wafer on which the devices have been formed is used, for example, it is possible to easily evaluate whether the defects that generate a device failure are on the front surface, which is a device layer, or the back surface. Since the defects on the surface directly affect yield of the devices in the wafer on which the devices have been formed, the evaluation of the surface defects, rather than the entire depth direction, can still contribute to improving the yield.

### Advantageous Effects of Invention

As described above, according to the inventive method for evaluating a defect position in a depth direction of a wafer, it is sufficient to obtain only two images through normal usage of X-ray topography (XRT), and the measurement can be performed in a short time, additionally, special usages such as intensifying synchrotron radiation or narrowing the measurement region are not performed, resulting in versatility. As a result, it is possible to evaluate the defect positions in the depth direction of the wafer using the extremely simple and easy method.

### BRIEF DESCRIPTION OF DRAWINGS

FIG. 1 is a schematic explanatory view of an embodiment in a method for evaluating a defect position in a depth direction of a wafer according to the present invention.

FIG. 2 is a schematic view of a case where two XRT images are obtained by changing incident angles of X-ray.

FIG. 3 is a schematic view of a case where two XRT images are obtained by rotating a wafer.

FIG. 4 is a schematic explanatory view of another embodiment according to the present invention.

FIG. 5 is a schematic explanatory view illustrating difference between cases of X-ray incidence from one direction and from two directions.

FIG. 6 is a schematic view of incident angles that satisfy diffraction and diffractions of a wafer.

FIG. 7 is photographs to describe an effect of Example 1 according to the present invention.

FIG. 8 is photographs to describe Example 2 according to the present invention.

FIG. 9 is a schematic view of a case where defects penetrate from a front surface to a back surface of a wafer.

FIG. 10 is a photograph of a case in which intricate dislocation is present in a wafer.

### DESCRIPTION OF EMBODIMENTS

As described above, in a method for evaluating a wafer using X-ray topography (XRT), a short, versatile, and consequently, very simple method for evaluating a defect position in a depth direction of a wafer is desired.

To solve the above problem, the present inventors have earnestly studied and found out that by irradiating a front surface of the wafer with an X-ray from a right direction and a left direction at an incident angle satisfying diffraction conditions to obtain two XRT images, being a right-eye image and a left-eye image, on the back surface; the defect positions in a depth direction of a wafer can be evaluated by the short, versatile, and consequently, very simple method. Based on this finding, the present invention has been completed.

That is, the present invention is a method for evaluating a defect position in a depth direction of a wafer using X-ray topography (XRT), the method comprising the steps of:
irradiating a front surface of the wafer that has the front surface and a back surface with an X-ray from a right direction and a left direction at an incident angle satisfying diffraction conditions to obtain two XRT images, being a right-eye image and a left-eye image, on the back surface;
position-adjusting to adjust the two obtained XRT images at the defect position on any one of the front surface and the back surface; and
determining the defect position to determine another defect position, where the depth direction of the wafer is different, based on a displacement between the right-eye image and the left-eye image.

Moreover, the present invention is a method for evaluating a defect position in a depth direction of a wafer using X-ray topography (XRT), wherein
by irradiating a front surface of the wafer that has the front surface and a back surface with an X-ray from a right direction and a left direction at an incident angle satisfying diffraction conditions to obtain two XRT images, being a right-eye image and a left-eye image, on the back surface and then by visually capturing the two XRT images as a single image, the defect position in the depth direction is observed through stereoscopic viewing (3D image).

Hereinafter, the present invention will be described in detail. However, the present invention is not limited thereto.

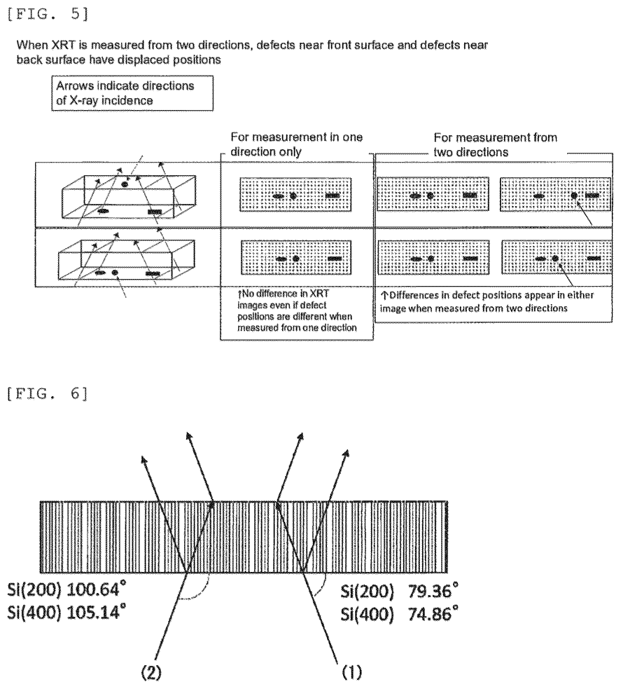

First, using FIG. 5, how defects are observed as images depending on the incident directions of the X-ray is described. TWO wafers with different defect positions are shown at the left in FIG. 5. To begin with, the wafer in the drawing above has oval and rectangular defects on a lower surface and a circular defect on an upper surface. The wafer in the drawing below has oval, rectangular, and circular defects on a lower surface. The only difference between the upper wafer and the lower wafer is the position of the circular defects; the circular defect is not only in a different position on the upper and lower but also the left and right, with the circular defect on the wafer in the drawing above being positioned slightly to right. Moreover, arrows heading from the bottom to the top of the drawing indicate the direction of the X-ray incidence, and the wafer is irradiated with X-rays from two directions: the first direction heading from the lower left to the upper right, and the second direction heading from the lower right to the upper left. The X-rays in these two directions are incident separately, and each XRT image is obtained above the wafer. In this case, each image is referred to as the left-eye image and the right-eye image, using an analogy from the way a person observes with eyes from the top.

The center of FIG. 5 shows the XRT images from only one direction (only the XRT images in the first direction (the left-eye images)), but the image in the drawing above and the image in the drawing below have no difference. These images show the result of the positions of the circular defects being matched due to two phenomena: the positions of the circular defects (defects are positioned at the left side on the lower surface in the drawing below and at the right side on the upper surface in the drawing above) are displaced; and the defects on the lower surface generated by the incident angle from the lower left to the upper right are displaced significantly further to the right side from the defects on the upper surface. In other words, when measurement is performed from only one direction, it is possible that even when the defect positions are different, the X-ray images may have no difference.

The right side in FIG. 5 shows the two directions (both the XRT image in the first direction (left-eye image) and the XRT image in the second direction (right-eye image). The left-eye image is the same as in a previous case, but the right-eye image has significantly different positions of circular defects between the images in the drawing above and below. That is, by measuring in two directions, the difference in the defect positions appears on the image in at least one direction. Conversely, this indicates that when a difference in the defect positions appears in the image and when the lower surface is defined as a reference, it can be found that the defects are on the different surface in an upward direction, and thus, the defect positions in a different depth direction can be determined.

The method at this time is a method utilizing an effect that the defect positions change depending on the depth positions when the images from different directions, i.e., the right-eye image and the left-eye image, are overlayed. The XRT image taken from a single direction, as typically performed, does not provide differences due to depth displacement.

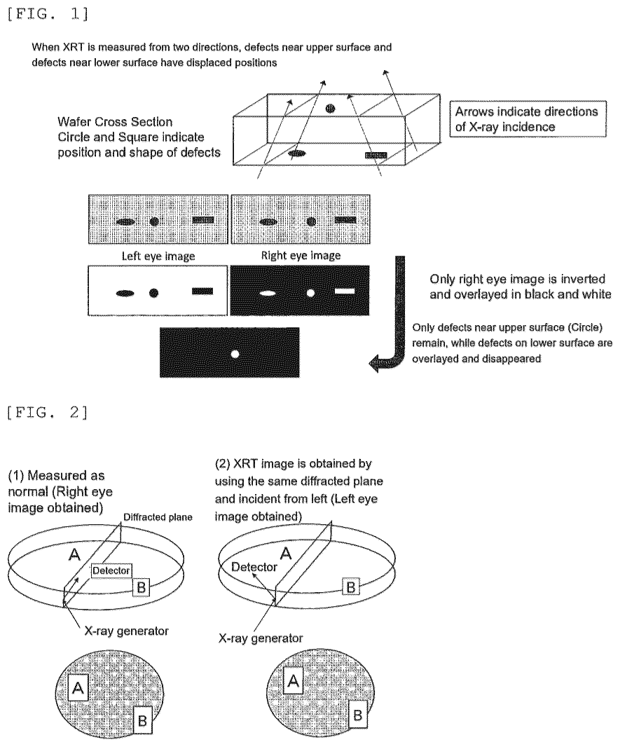

Hereinafter, an embodiment of the present invention will be described with reference to FIGS. 1 and 2.

The wafer is arranged making the front surface the lower surface and the back surface the upper surface, and the measurements are performed twice by typical transmission XRT. In this case, as shown in the drawing above in FIG. 1, the X-rays are obliquely incident from the left direction and right direction on the same diffracted plane, and measurements are performed for each. Since the X-rays are obliquely incident to the sample, the images obtained from the defects have displaced positions depending on defect depth. By obtaining these results as the left-eye image and right-eye image, respectively, and comparing these, the positions in a depth direction can be evaluated based on the difference of the defect positions.

In FIG. 1, the positions of the defects (oval, rectangular) near the front surface (lower surface) do not change between the right-eye image and the left-eye image. However, the position of the image of the defect (circular) near the back surface (upper surface) changes. When only the defect, which position changes between the right-eye image and the left-eye image, is extracted, this defect can be identified as the defect near the back surface.

By inverting the right-eye image of the obtained X-ray topographic image to black-and-white and overlaying thereof on the left-eye image while adjusting the defect positions (oval or rectangular) near the front surface (lower surface) to align; a place where the defect position displacement is generated, i.e., only the circular defect on the back surface (upper surface) can be highlighted.

Note that FIG. 2 shows a positional relationship among an X-ray generator, a detector, and a sample when obtaining the right-eye image and the left-eye image in a case of an apparatus in which the generator and the detector move freely. When obtaining the right-eye image, the generator may be arranged on the right side, and when obtaining the left-eye image, the generator may be arranged on the left side.

In this way, the X-rays are incident from the left and right sides to perform the measurement, and it is desirable to set the incidence from the left and right sides such that the same diffracted plane can be measured. Specifically, in the measurement of a (100) silicon wafer, (400) diffraction or (220) diffraction is often used for measurement. When the (400) diffraction is used for the incident angle, the incident angle from the right direction is 74.86°, and the incident angle from the left direction is 105.15°. When the (220) diffraction is used for the incident angle, the incident angle from the right direction is 79.36°, and the incident angle from the left direction is 100.64°. However, the wafer has an off-angle, and the diffraction rarely occurs at the incident angle described above and is often displaced by a few degrees to a few minutes.

Moreover, in a SiC wafer, a (11-20) diffracted plane is often used for measurement. In this case, the incident angle from the right direction is 76.66°, and the incident angle from the left direction is 103.34°.

A commonly used XRT measurement is often measured using a monochromatic X-ray, and in such a case, the diffraction angle is required to be strictly determined. However, since XRT using a non-monochromatic X-ray has been present in recent years, in this case, the diffraction angle is not required to be so precise. Specifically, as long as the XRT image can be obtained, the diffraction angle may be displaced without any problems.

Moreover, when measuring twice, once from the left and once from the right side, a stereoscopic view can be obtained visually by measuring at the same diffracted planes, but it is also possible to compare the images under different diffracted conditions.

Although the image in which the X-ray is incident from the left is referred to as the left-eye image and the image in which the X-ray is incident from the right is referred to as the right-eye image, the right-eye image and the left-eye image may be exchanged as long as the two XRT images can be compared, and thus the exchange of the right-eye image and the left-eye image is not problematic. When the generator or the detector of the X-ray is unable to be moved to an inverse position due to a limitation of the apparatus, the sample may be rotated 180 degrees and measured at the same angle, and the measured results may be rotated 180 degrees.

As described above, one embodiment of the present invention describes that the method for evaluating a defect position in a depth direction of a wafer using X-ray topography (XRT) includes the steps of irradiating the front surface (lower surface) of the wafer that has the front surface (lower surface) and the back surface (upper surface) with the X-ray from the right direction and the left direction at the incident angle satisfying diffraction conditions to obtain two XRT images, being the right-eye image and the left-eye image, on the back surface (upper surface), position-adjusting to adjust the two obtained XRT images at the defect position on the surface of the front surface, and determining the defect position to determine another defect position, where the depth direction of the wafer is different, based on the displacement between the right-eye image and the left-eye image, thereby the defect position can be determined on the back surface (upper surface) where the depth direction of the wafer is different.

According to the method for evaluating a defect position in a depth direction of a wafer, the right-eye image and the left-eye image are matched for the defects on the position-adjusted front surfaces. However, for the defects on the back surface, which are different from the position-adjusted surface, the displacement occurs between the right-eye image and the left-eye image, and this displacement allows determination that these defects are defects having different positions in a depth direction. With this method, it is sufficient to obtain only two images through normal usage of X-ray topography (XRT), and the measurement can be performed in a short time, additionally, special usages such as intensifying synchrotron radiation or narrowing the measurement region are not performed, resulting in versatility. As a result, it is possible to evaluate the defect positions in the depth direction of the wafer by an extremely simple and easy method.

Note that although the defect positions in the depth direction of the wafer have been described with respect to the defect positions on the front surface and the back surface, it is also possible to observe inside the wafer.

Moreover, in the step of determining the defect position, by inverting the right-eye image from two obtained XRT images into black-and-white and combining thereof with the left-eye image, the circular defect position on the back surface (upper surface) can be determined.

Such a step of determining the defect position can reliably determine the defect positions based on the difference in color between white and black, and thus can be suitably applied to the method for evaluating a defect position in a depth direction of a wafer.

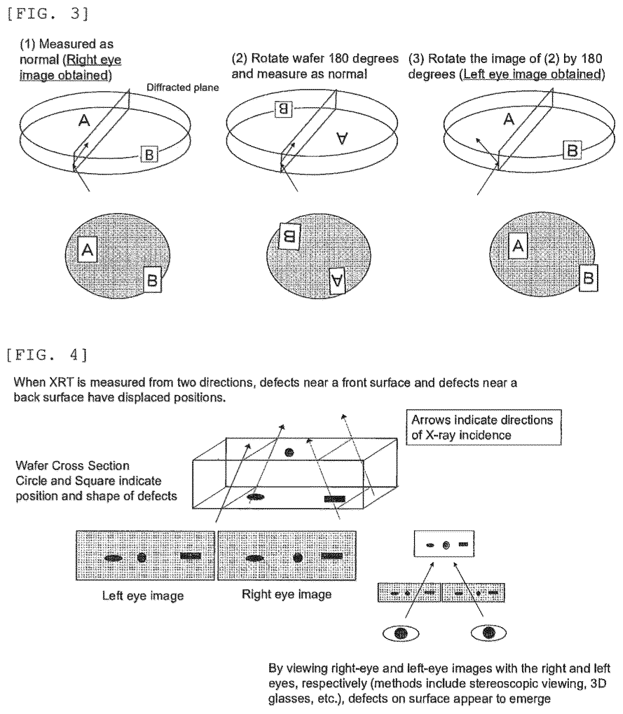

Hereinafter, another embodiment of the present invention will be described with reference to FIG. 3.

When a generator and a detector of the X-ray are unable to be moved to an inverse position due to a limitation of the apparatus, a right-eye image and a left-eye image can be obtained, as shown in FIG. 3.
1. The right-eye image is obtained by irradiating with X-ray from a right direction.
2. A wafer is rotated 180°, and the wafer is irradiated with the X-ray from the right direction at the same irradiation angle to obtain the image. FIG. 3 shows that when the wafer labeled A and B is rotated 180°, the wafer appears to be inverted on the left and right.
3. A left-eye image is obtained.

By rotating the image obtained in “2” by 180°, the image becomes the same as an X-ray topography image obtained by irradiating from the left direction without rotating the wafer.

In this embodiment, by inverting black-and-white of either the obtained right-eye image and left-eye image, being the X-ray topography images, and overlaying these images, it is then possible to highlight a place where the defect position displacements are generated, i.e., the defects being on the surface.

As described above, according to the method for evaluating a defect position in a depth direction of a wafer of this embodiment, it is possible to show that the method for incident with the x-ray from a right direction and a left direction at an incident angle Satisfying diffraction conditions to the front surface includes: fixing the incident angle to the right direction and irradiating with the X-ray to obtain the XRT image (right-eye image); the wafer is then rotated 180° and irradiating with the X-ray to obtain the XRT image in other direction; obtaining two images, being the right-eye image and the left-eye image by rotating the image obtained above to 180°.

With such a method, even when the generator or the detector of the X-ray is unable to be moved, the XRT images in the right direction and the left direction can be easily obtained; therefore, the defect positions in a depth direction of the wafer can be evaluated by an extremely simple and easy method.

Note that even in this embodiment, by capturing the obtained right-eye image and left-eye image as a single image, it is possible to observe thereof by stereoscopic viewing (3D image), and it is also possible to easily distinguish between the front surface defects and the back surface defects.

Note that, in principle, it is possible to evaluate the surface defects on the side opposite the X-ray irradiated surface from the displacement of the positions of the front surface defects on the side opposite the X-ray irradiated surface by combining the defect positions on the X-ray irradiated surface. Conversely, it is also possible to evaluate the defects on the X-ray irradiated surface due to displacement of the defect positions on the X-ray irradiated surface when the defect positions on the surface the side opposite the X-ray irradiated surface are combined.

Hereinafter, another embodiment of the present invention will be described with reference to FIG. 4.

As another method, a stereo image of defects can also be obtained by a stereoscopic viewing of two images.

A right-eye image and a left-eye image are obtained by the same method as in the embodiment described above (a front surface is irradiated with X-ray from a right direction and a left direction at an incident angle satisfying diffraction conditions to obtain two XRT images, being the right-eye image and the left-eye image on a back surface). By viewing these images from a right eye and a left eye, respectively, the defects present on the front surface appear to pop out by methods such as stereoscopic viewing and 3D glasses. In FIG. 4, a circular defect on the back surface (upper surface) of the wafer appears to pop out.

As described above, through the method for evaluating a defect position in a depth direction of a wafer of the present embodiment; the method for evaluating a defect position in a depth direction of a wafer is described, in which, by irradiating the front surface of the wafer that has the front surface and the back surface with X-ray from the right direction and the left direction at an incident angle satisfying diffraction conditions to obtain two XRT images, being the right-eye image and the left-eye image, on the back surface and then by visually capturing the two XRT images as a single image; the defect positions in the depth direction are observed through stereoscopic viewing (3D image).

With such a method for evaluating a defect position in a depth direction of a wafer, when attempting to visually capture the two XRT images as a single image and the defects having different positions in the depth direction are present, the two images are viewed stereoscopically due to displacement therebetween. Consequently, stereoscopic appearance allows determining that these are the defects with different positions in the depth direction (circular defect on the back surface (upper surface) ). With this method, it is sufficient to obtain only two images through normal usage of X-ray topography (XRT), and the measurement can be performed in a short time, additionally, special usages such as intensifying synchrotron radiation or narrowing a measurement region are not performed, resulting in versatility. In addition, since the evaluation of the defect position is performed visually, no separate preparation of the evaluation apparatus, etc., is required. As a result, it is possible to evaluate the defect positions in the depth direction of the wafer by the extremely simple and easy method.

Note that the present invention is not limited to a silicon wafer and is applicable to a SiC wafer or a silicon wafer on which devices have been formed.

The SiC wafer may have a case where crystal defects are intricately intertwined within a crystal, and the situation therein can be confirmed. Moreover, since surface defects directly affect device yield at the silicon wafer on which the devices have been formed, XRT can be used to evaluate only the surface defects, not the entire depth direction.

Furthermore, regarding these wafers, the present invention is effective when it is desired to determine a three-dimensional structure of the defects in the wafers.

### EXAMPLES

Hereinafter, the results of actually evaluating samples are specifically described using photographs and drawings, etc.

### Example 1

First, a carbon film was grown by vapor-phase deposition on an upper surface of a silicon wafer having a plane orientation of (100). Scratches formed on a back surface due to handling at this time were evaluated. A front surface side as an X-ray incident surface was irradiated with X-ray from direction (1) shown in FIG. 6, and XRT measurement was performed. In this case, an incident angle was set to 74.86° because the measurement was performed under (400) diffraction conditions.

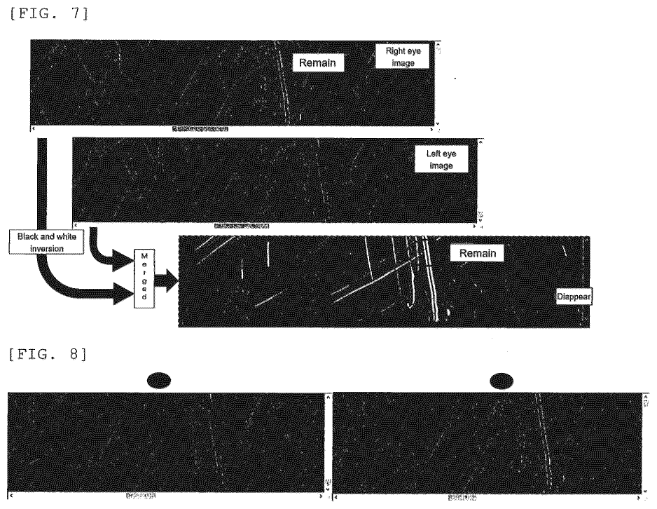

Since an X-ray generator of an apparatus used this time was not movable to a position in (2) direction, the wafer was rotated 180 degrees, and XRT was measured again after irradiating from (1) direction. Subsequently, a second measurement result was rotated 180 degrees to make a positional relationship the same as the first measurement. FIG. 7 shows a case where an image taken in (1) is a right-eye image, an image taken in (2) is a left-eye image, and an image is obtained by inverting one of the images to black-and-white and overlaying both images. In this case, surface defect positions were matched. Defects visible as linear cracks, which were the defects on the front surface, were negated each other and disappeared, leaving only contact scratches on the back side visible.

### Example 2

Moreover, as shown in FIG. 8, it is also possible to visually observe stereoscopic viewing (3D image) by matching respective round dots above a right-eye image and a left-eye image to perceive a single image, and it is also possible to obtain depth information of defects even by this method.

The images in FIG. 8 are the same as the images shown in FIG. 7, but it is possible to view the images stereoscopically by matching round dots above the images. These data are results of cases where the defects are present on both a front surface and a back surface of a Si wafer, but when the defects are generated not only on the front surface and the back surface of a crystal but also inside the crystal such as slip in a Si crystal or defects in SiC, the method by this stereoscopic viewing (3D image) is more effective because defects at intermediate of crystal bulk can be recognized.

Furthermore, examples in which the stereoscopic viewing is considered to be effective are supplemented.

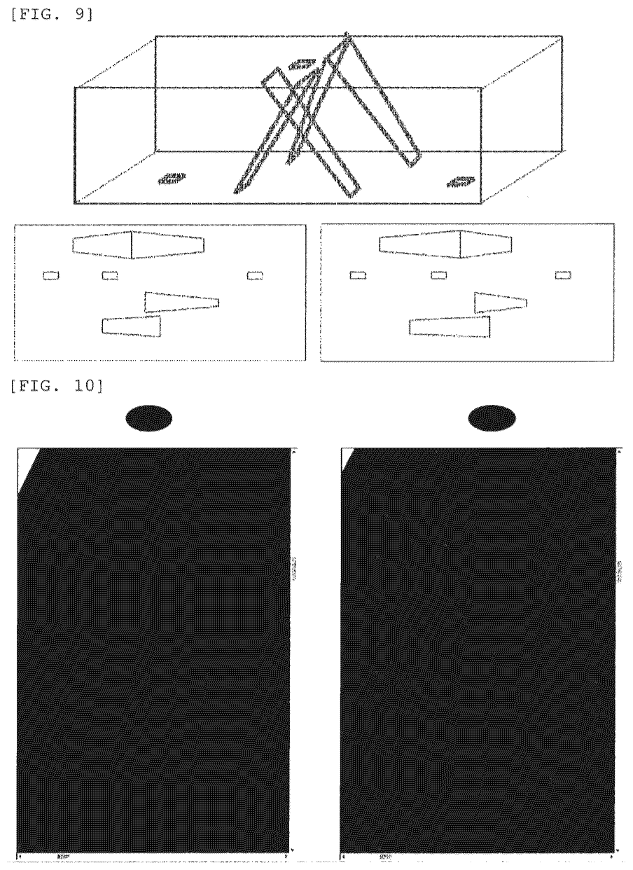

FIG. 9 shows a schematic view of a case where defects penetrate from a front surface to a back surface of a wafer and an example of stereoscopic viewing.

FIG. 10 is an example of a case in which intricate dislocation is present in a crystal. In cases such as FIGS. 9 and 10, it is easier to grasp an overall image of the defects by confirming thereof using stereoscopic viewing.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1-5. (canceled)

6. A method for evaluating a defect position in a depth direction of a wafer using X-ray topography (XRT), the method comprising the steps of:
irradiating a front surface of the wafer that has the front surface and a back surface with an X-ray from a right direction and a left direction at an incident angle satisfying diffraction conditions to obtain two XRT images, being a right-eye image and a left-eye image, on the back surface;
position-adjusting to adjust the two obtained XRT images at the defect position on any one of the front surface and the back surface; and
determining the defect position to determine another defect position, where the position in the depth direction of the wafer is different, based on a displacement between the right-eye image and the left-eye image.

7. The method for evaluating a defect position in a depth direction of a wafer according to claim 6, wherein
the method for irradiating the front surface with the X-ray from the right direction and the left direction at the incident angle satisfying the diffraction conditions obtains the two XRT images, being the right-eye image and the left-eye image, by fixing an incident angle in either direction of the right direction or the left direction and obtaining the XRT image by irradiating the X-ray and then rotating the wafer by 180° and then obtaining the XRT image from another direction by irradiating with the X-ray.

8. The method for evaluating a defect position in a depth direction of a wafer according to claim 6, wherein
the step of determining the defect position determines the defect position by inverting black-and-white of any one of the two obtained XRT images and combining thereof.

9. The method for evaluating a defect position in a depth direction of a wafer according to claim 7, wherein
the step of determining the defect position determines the defect position by inverting black-and-white of any one of the two obtained XRT images and combining thereof.

10. A method for evaluating a defect position in a depth direction of a wafer using X-ray topography (XRT), wherein
by irradiating a front surface of the wafer that has the front surface and a back surface with an X-ray from a right direction and a left direction at an incident angle satisfying diffraction conditions to obtain two XRT images, being a right-eye image and a left-eye image, on the back surface and then by visually capturing the two XRT images as a single image, the defect position in the depth direction is observed through stereoscopic viewing (3D image).

11. The method for evaluating a defect position in a depth direction of a wafer according to claim 6, wherein
the wafer is at least one of a single crystal wafer and a wafer on which a device has been formed.

12. The method for evaluating a defect position in a depth direction of a wafer according to claim 10, wherein
the wafer is at least one of a single crystal wafer and a wafer on which a device has been formed.
